(19) United States
(12) Patent Application Publication
(10) Pub. No.: US 2012/0008329 A1
(43) Pub. Date: Jan. 12, 2012

(54) LED STREET LAMP

(75) Inventor: Chin-Wen WANG, Pingzhen City (TW)

(73) Assignees: LEADER TREND TECHNOLOGY CORP.; Chin-Wen WANG

(21) Appl. No.: 12/830,616

(22) Filed: Jul. 6, 2010

(51) Int. Cl. F21V 19/02; F21V 29/00

(52) U.S. Cl. 362/372; 362/373

(57) ABSTRACT

A LED street lamp including a housing, a lighting module, a metal base, and a heat dissipating module. The housing includes a bottom shell and a top shell both with openings. The lighting module is arranged in the housing. The heat dissipating module includes a metal base, a plurality of heat pipes, and a plurality of heat dissipating fins. The metal base includes a first plate and a second plate attached together. The first plate is thermally contacted with the lighting module. The heat pipes each have a heat absorbing section and a heat dissipating section. The heat absorbing section is arranged between the first plate and the second plate. The heat dissipating section is extending away from a side of the metal base. The heat dissipating fins are arranged on the heat dissipating sections. Air in the housing can naturally flow upwardly to effectively dissipate operating heat.

### BACKGROUND OF THE INVENTION

1. Field of the Invention

The present invention relates to a lighting apparatus, particularly to a LED street lamp.

2. Description of Related Art

Since the operating heat generated from the light emitting diode (LED) has a negative affection to the lifetime of the LED, LED light sources such as LED street lamps usually have heat dissipating device to help removing the operating heat of the LED. However, with the increasing number of LEDs and the adopting of high-powered LEDs in the LED light source, the amount of the operating heat is increasing rapidly. Therefore, how to improve the dissipating efficiency of the heat dissipating device for the LED light source has become a major issue in this industry.

Conventional LED street lamp has a lamp housing, a plurality of LEDs arranged in the lamp housing, and a heat dissipating device arranged above the LEDs. For example, the hest dissipating device could have a base and a plurality of fins connected to the base for dissipating the operating heat.

However, the lamp housing has openings only on its lateral side and top side. There is no opening on the bottom side of the LEDs. The heat dissipating device arranged above the LEDs could obstruct the heated air in the lamp housing from naturally flowing upwardly, and the cold air flows in from the openings can only flow out horizontally through the openings. Since the air flowing path is not smooth enough to dissipate the heated air, the operating heat generated from the LEDs can not be effectively dissipated.

Accordingly, the invention to be described hereinafter is provided through dedicated research and is appropriately designed, and can effective overcome the above-mentioned inconvenience.

### SUMMARY OF THE INVENTION

The objective of the present invention is to provide a LED street lamp having corresponding heat dissipating holes on both the top and bottom shell so as to allow heated air in the lamp housing to naturally flow upwardly and effectively increase the speed of airflow to dissipate operating heat generated from the LEDs.

Accordingly, the present invention provides a LED street lamp including a lamp housing, a lighting module, a metal base, a plurality of heat pipes, and a plurality of heat dissipating fins. The lamp housing including a bottom shell and a top shell accordingly covered on the bottom shell. The bottom shell and the top shell cooperatively define an accommodating space. The bottom shell is formed with a opening and a plurality of first heat dissipating holes away from the opening. The top shell is formed with a plurality of second heat dissipating holes corresponding to the first heat dissipating holes. The lighting module is arranged in the accommodating space and corresponding to the opening. The lighting module includes a circuit board and a plurality of LEDs disposed on the circuit board. The metal base includes a first plate and a second plate attached with the first plate. The first plate is thermally contacted with the circuit board. The heat pipes each have a heat absorbing section and a heat dissipating section. The heat absorbing section is horizontally arranged between the first plate and the second plate. The heat dissipating section is horizontally extending away from a lateral side of the metal base. The heat dissipating fins are arranged on the heat dissipating sections of the heat pipes and being parallel to each other.

Another objective of the present invention is to provide a LED street lamp having a lighting module arranged at one side in the housing thereof and heat dissipating fins with heat pipes arranged at another side in the housing. Such an optimized arrangement could be helpful for decreasing the thickness of the housing.

Another objective of the present invention is to provide a LED street lamp having a lighting module and heat dissipating module arranged at opposite sides in the housing thereof, so as to avoid obstructing airflow in the lamp housing and increase the speed of airflow.

Another objective of the present invention is to provide a LED street lamp having heat dissipating holes on the housing thereof to help dissipating heated air and outside moisture can not damage the electrical performance of the lighting module.

The present invention provides a LED street lamp having a lighting module arranged at one side in the housing and heat dissipating fins with heat pipes arranged at another side in the housing, and corresponding heat dissipating holes on both the top and bottom shell. The arrangement in housing is optimized to help decreasing the thickness of the housing. Air can flow upwardly into the lamp housing through the holes on the bottom shell and then bring away the heat on the heat dissipating fins and flow out from the holes on the top shell. The heated air in the lamp housing can naturally flow upwardly so as to improve the heat dissipating efficiency and lower down the temperature of the lighting module.

### BRIEF DESCRIPTION OF THE DRAWINGS

FIG. 1 is a perceptively view of the LED street lamp of the present invention;

FIG. 2 is an exploded view of the LED street lamp of the present invention;

FIG. 3 is a cross-sectional view of the LED street lamp of the present invention;

FIG. 4 is an expanded sectional view of the LED street lamp of the present invention;

FIG. 5 illustrates a schematic view about the angle adjustment of the LED street lamp of the present invention;

FIG. 6 illustrates a schematic view about the practical operation of the LED street lamp of the present invention; and

FIG. 7 is a bottom view of the LED street lamp of the present invention.

### DETAILED DESCRIPTION OF THE INVENTION

The present invention is described below in detailed with the reference to accompanying drawings. It should be mentioned that the drawings provided for illustration only and the invention is not limited to the drawings.

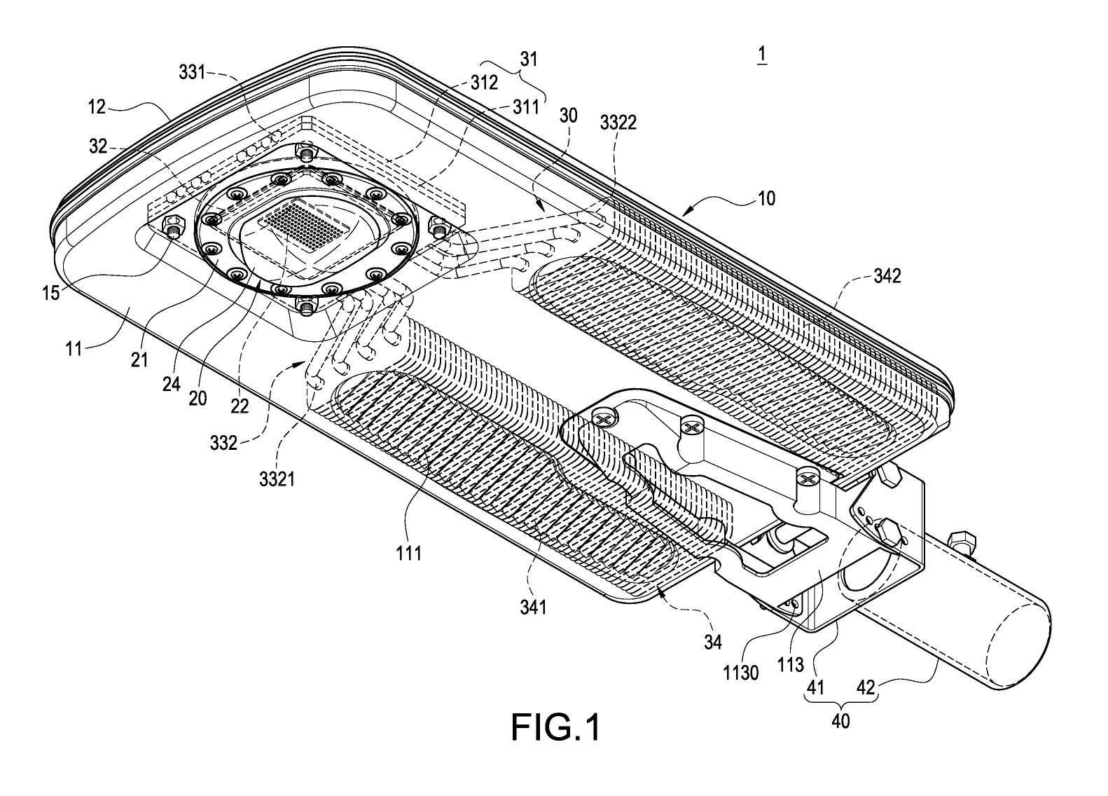

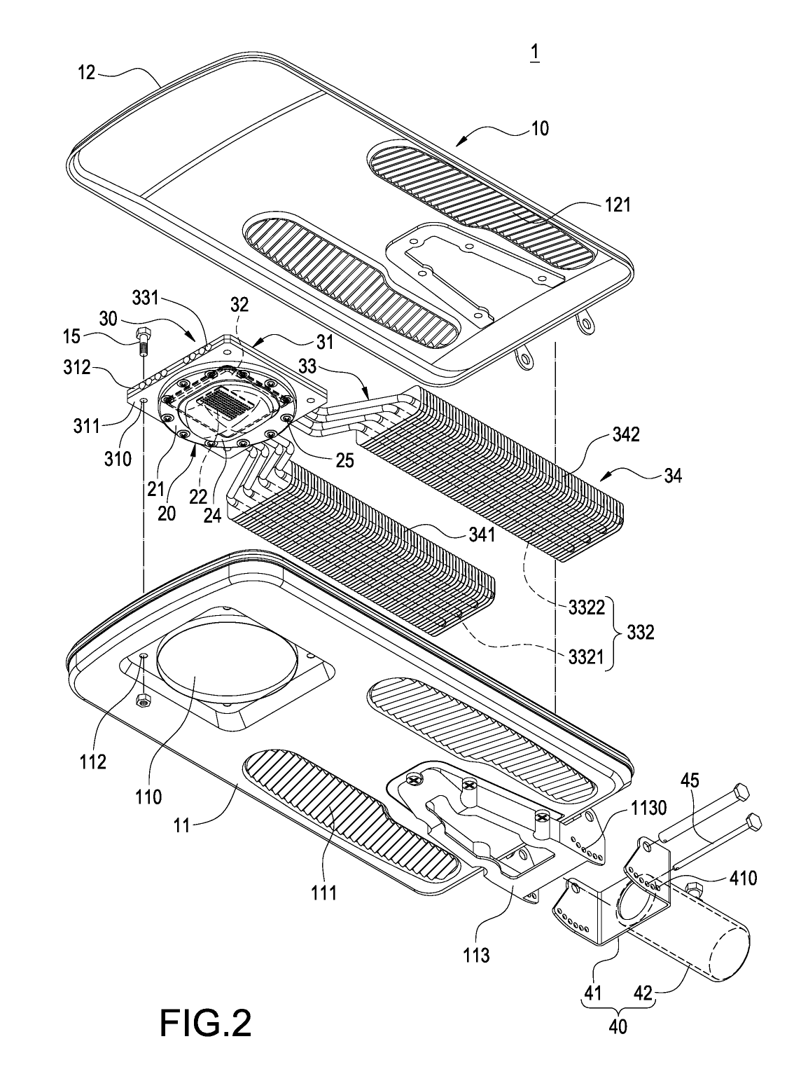

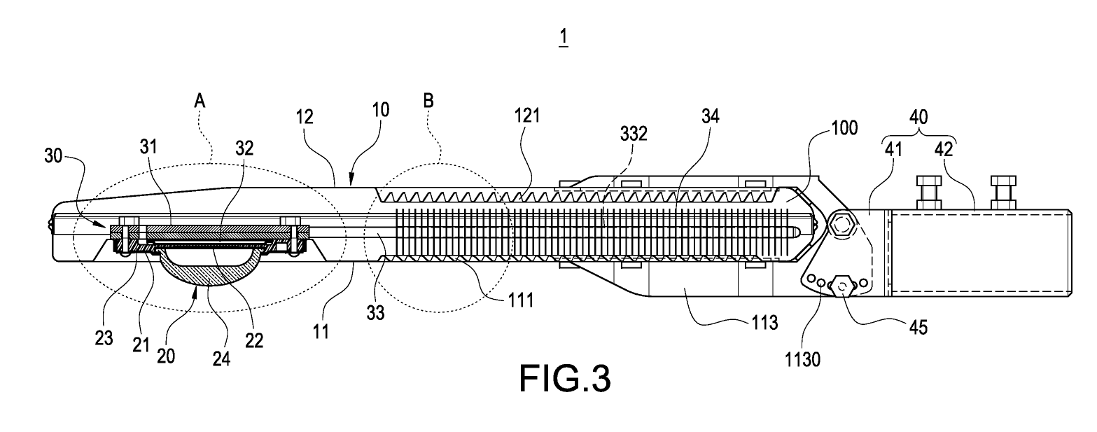

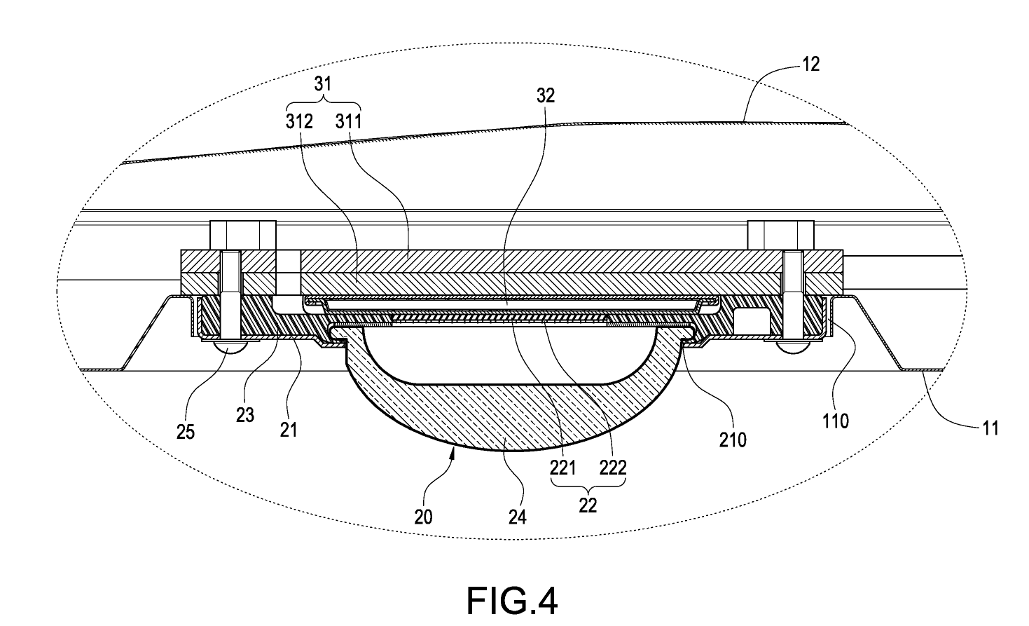

FIG. 1 to FIG. 4 are respectively a perceptively view, an exploded view, a cross-sectional view and an expanded sectional view of the LED street lamp according to the first embodiment of the present invention. The LED street lamp includes a lamp housing 10, a LED module 20, and a heat dissipating module 30 connected with the LED module 20.

The lamp housing 10 includes a bottom shell 11 and a top shell 12 accordingly covered on the bottom shell 11. The bottom shell 11 and the top shell 12 cooperatively define an accommodating space 100. The bottom shell 11 is formed with an opening 110 and a plurality of first heat dissipating holes 111 away from the opening 110. The top shell 12 is formed with a plurality of second heat dissipating holes 121 corresponding to the first heat dissipating holes 111. In this embodiment, the first heat dissipating holes 111 and the second heat dissipating holes 121 are formed in comb shape. The first heat dissipating holes 111 are formed at two opposite sides of the bottom shell 11 and the second heat dissipating holes 121 are formed at two opposite sides of the top shell 12. In addition, the bottom shell 11 has a connecting base 113 adjacent to the first heat dissipating holes 111.

The LED module 20 includes a lamp base 21, a lighting module 22 connected to the lamp base 21, an encapsulant 23 and a lens 24. The lamp base 21 and the lighting module 22 are located in the accommodating space 100. The lighting module 22 is arranged in an opening 210 of the lamp base 21 and is corresponding to the opening 110 of the bottom shell 11. The lighting module 22 includes a circuit board 221 and a plurality of LEDs 222 disposed on the circuit board 221. The encapsulant 23 is attached on the inner surface of the lamp base 21 and covers the edge of the lens 24. The lens 24 is located on the outer side of the lighting module 22 and seals the opening 210 of the lamp base 21.

The heat dissipating module 30 includes a metal base 31, a vapor chamber heat sink 33, a plurality of heat pipes 33 and a plurality of heat dissipating fins 34. The metal base 31 is connected to the lamp base 21 and includes a first plate 311 and a second plate 312 attached with the first plate 311. The vapor chamber heat sink 32 is arranged between the lighting module 22 and the first plate 311 and is contacted with the first plate 311. The first plate 311 is thermally contacted with the circuit board 221 of the lighting module 22.

The heat pipes 33 each have a heat absorbing section 331 and a heat dissipating section 332. The heat absorbing section 331 is horizontally arranged between the first plate 311 and the second plate 312. The heat dissipating section 332 horizontally extends away from a lateral side of the metal base 30. The heat dissipating fins 34 are arranged on the heat dissipating sections 332 of the heat pipes 33 and are parallel to each other.

In this embodiment, the heat dissipating section 331 has a first heat dissipating section 3321 and a second heat dissipating section 3322. The first heat dissipating section 3321 extends toward a side of the lamp housing 10 and the second heat dissipating section 3322 extends toward another side of the lamp housing 10. Similarly, the heat dissipating fins 34 include a plurality of first heat dissipating fins 341 and a plurality of second heat dissipating fins 342. The first heat dissipating fins 341 pass through the first heat dissipating section 3321 and the second heat dissipating fins 342 pass through the second heat dissipating section 3322.

In practical manufacturing, the LED module 20 is fixed in the metal base 31 by a plurality of screws 25. Then, the LED module 20 is arranged in the opening 110 of the bottom shell 11. A plurality of fixing holes 112 are formed adjacent to the opening 110 of the bottom shell 11. The first plate 311 and the second plate 312 each have a plurality of screw holes 310. A plurality of screws 15 are provided to insert into the screw holes 310 and fixing holes 112 for fixing the metal base 31 onto the bottom shell 11. Finally, the top shell 12 is accordingly covered on the bottom shell 11.

In addition, the LED street lamp 1 can further include an adjustable lamp post 40 and a detent pin 45. The adjustable lamp post 40 includes a fixing frame 41 and a tube 42 connected to the fixing frame 41. The tube 42 can be connected to a lamp post (not shown). The connecting base 113 of the bottom shell 11 has a plurality of first pivotal holes 1130. The connecting frame 41 has a plurality of second pivotal holes 410 corresponding to the first pivotal holes 1130. The detent pin 45 is inserted into one of the first pivotal holes 1130 and one of the second pivotal holes 410. Such that the adjustable lamp post 40 is pivotally connected to the connecting base 113.

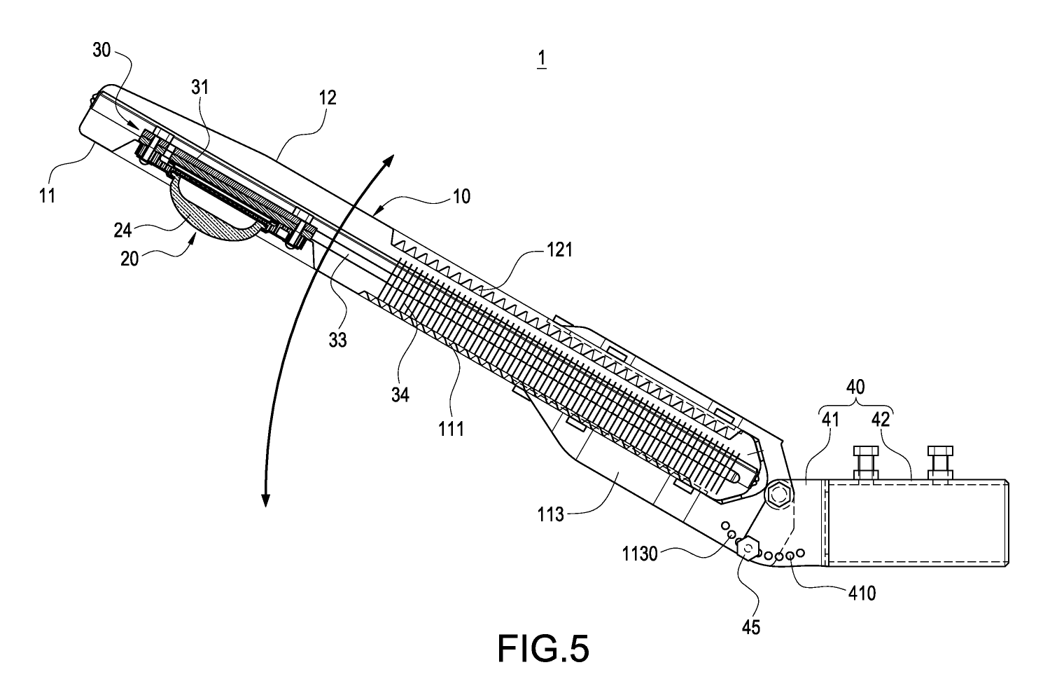

FIG. 5 illustrates a schematic view about the angle adjustment of the LED street lamp of the present invention. By inserting the detent pin 45 in different first pivotal holes 1130 and corresponding second pivotal holes 410, the angle between the tube 42 and the connecting base 113 can be adjusted, and the light projecting direction of the LED street lamp can be changed.

Accordingly, the operating heat generated from lighting module 22 can be transferred through the vapor chamber heat sink 32 to the metal base 31 and further transferred to the heat absorbing sections 331 of the heat pipes 33. Then, heat can be transferred to the heat dissipating sections 332 of the heat pipes 33 and to the heat dissipating fins 34. Finally, heat can be dissipated into air from the large-area heat dissipating fins 34.

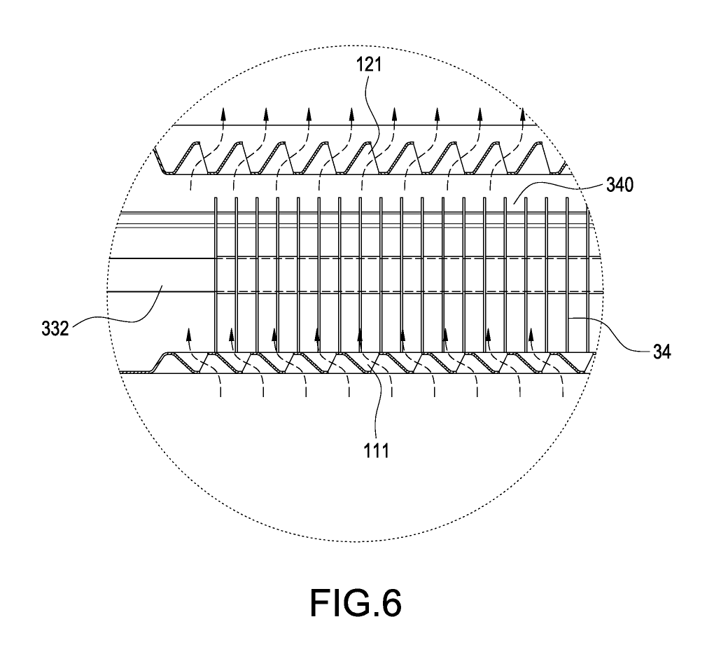

FIG. 6 illustrates a schematic view about the practical operation of the LED street lamp of the present invention. While the LED street lamp operating, exterior cold air can flow upwardly into the lamp housing 10 through the first heat dissipating holes 111 and then flow through the channels 340 between the heat dissipating fins 34. Then, the air can bring away the heat accumulated on the heat dissipating fins 34 and flow out from the second dissipating holes 121 on the top shell 12. Therefore, the heated air in the lamp housing 10 can naturally flow upwardly through convection so as to improve the heat dissipating efficiency and lower down the temperature of the lighting module 22.

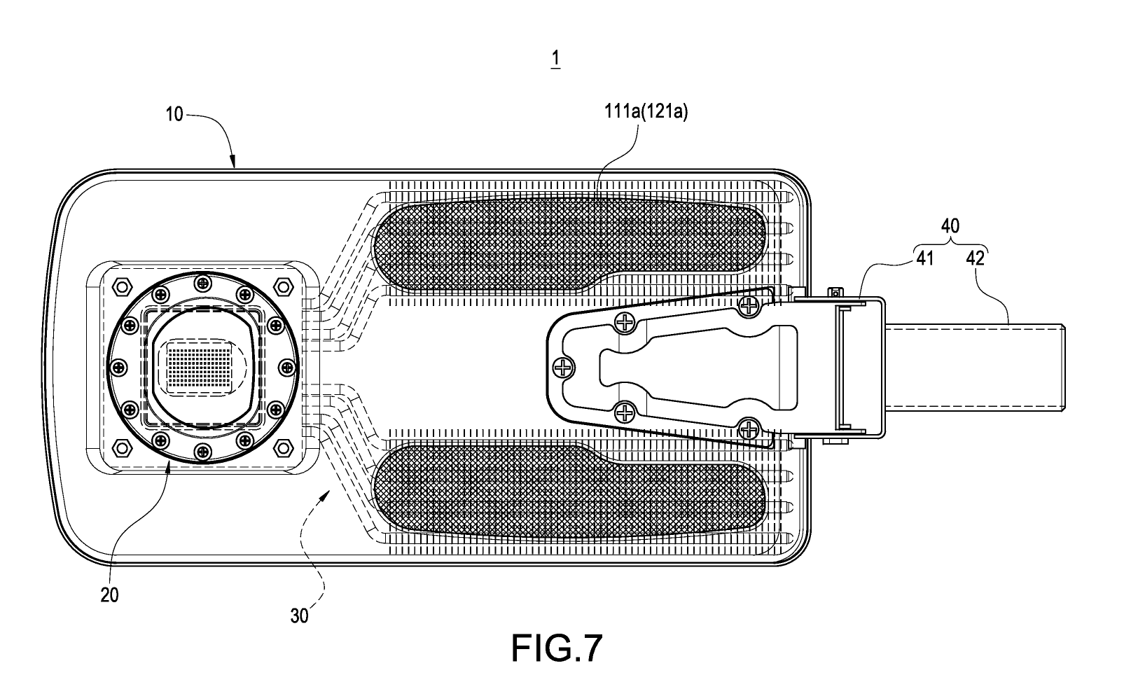

FIG. 7 shows the LED street lamp according to the second embodiment of the present invention. This embodiment is substantially the same with the first embodiment, and the difference is that the first heat dissipating holes 111a and the second heat dissipating holes 121a are formed in grid shape.

While the invention has been described by means of specific embodiments, numerous modifications and variations could be made thereto by those skilled in the art without departing from the scope and spirit of the invention set forth in the claims.

What is claimed is:

1. A LED street lamp, comprising:
a lamp housing comprising a bottom shell and a top shell accordingly covered on the bottom shell, the bottom shell and the top shell cooperatively defining an accommodating space, the bottom shell formed with an opening and a plurality of first heat dissipating holes away from the opening, the top shell formed with a plurality of second heat dissipating holes corresponding to the first heat dissipating holes;
a lighting module arranged in the accommodating space and corresponding to the opening, the lighting module comprising a circuit board and a plurality of LEDs disposed on the circuit board;
a metal base comprising a first plate and a second plate attached with the first plate, the first plate thermally contacted with the circuit board;
a plurality of heat pipes each comprising a heat absorbing section and a heat dissipating section, the heat absorbing section horizontally arranged between the first plate and the second plate, the heat dissipating section horizontally extending away from a lateral side of the metal base; and
a plurality of heat dissipating fins arranged on the heat dissipating sections of the heat pipes and being parallel to each other.

2. The LED street lamp as claim 1, wherein the first heat dissipating holes are formed at two opposite sides of the bottom shell and the second heat dissipating holes are formed at two opposite sides of the top shell.

3. The LED street lamp as claim 1, wherein the heat dissipating section has a first heat dissipating section and a second heat dissipating section, the first heat dissipating section extends toward a side of the lamp housing and the second heat dissipating section extends toward another side of the lamp housing.

4. The LED street lamp as claim 3, wherein the heat dissipating fins has a plurality of first heat dissipating fins and a plurality of second heat dissipating fins, the first heat dissipating fins are passed through the first heat dissipating section and the second heat dissipating fins are passed through the second heat dissipating section.

5. The LED street lamp as claim 1, wherein a plurality of fixing holes are formed adjacent to the opening of the bottom shell, the first plate and the second plate each have a plurality of screw holes and are fixed on the bottom shell.

6. The LED street lamp as claim 1, further comprising a vapor chamber heat sink arranged between the lighting module and the first plate and contacted with the first plate.

7. The LED street lamp as claim 1, further comprising a lamp base, wherein the lighting module and the metal base are connected to the lamp base.

8. A LED street lamp, comprising:
a lamp housing comprising a bottom shell and a top shell accordingly covered on the bottom shell, the bottom shell and the top shell cooperatively defining an accommodating space, the bottom shell formed with an opening and a plurality of first heat dissipating holes away from the opening, the top shell formed with a plurality of second heat dissipating holes corresponding to the first heat dissipating holes, the bottom shell comprising a connecting base adjacent to the first heat dissipating holes;
a lighting module arranged in the accommodating space and corresponding to the opening;
a metal base comprising a first plate and a second plate attached with the first plate, the first plate thermally contacted with the circuit board;
a plurality of heat pipes each comprising a heat absorbing section and a heat dissipating section, the heat absorbing section horizontally arranged between the first plate and the second plate, the heat dissipating section horizontally extending away from a lateral side of the metal base;
a plurality of heat dissipating fins arranged on the heat dissipating sections of the heat pipes and being parallel to each other; and
an adjustable lamp post comprising a fixing frame and a tube connected to the connecting frame, the connecting frame pivotally connected to the connecting base so as to adjust the angle between the tube and the connecting base.

9. The LED street lamp as claim 8, wherein the first heat dissipating holes are formed at two opposite sides of the bottom shell and the second heat dissipating holes are formed at two opposite sides of the top shell.

10. The LED street lamp as claim 9, wherein the heat dissipating section has a first heat dissipating section and a second heat dissipating section, the first heat dissipating section extends toward a side of the lamp housing and the second heat dissipating section extends toward another side of the lamp housing.

11. The LED street lamp as claim 10, wherein the heat dissipating fins has a plurality of first heat dissipating fins and a plurality of second heat dissipating fins, the first heat dissipating fins are passed through on the first heat dissipating section and the second heat dissipating fins are passed through the second heat dissipating section.

12. The LED street lamp as claim 8, wherein a plurality of fixing holes are formed adjacent to the opening of the bottom shell, the first plate and the second plate each have a plurality of screw holes and are fixed on the bottom shell.

13. The LED street lamp as claim 8, further comprising an detent pin, the connecting base having a plurality of first pivotal holes, the connecting frame having a plurality of second pivotal holes, the detent pin inserted into one of the first pivotal holes and one of the second pivotal holes.

14. The LED street lamp as claim 8, further comprising a vapor chamber heat sink arranged between the lighting module and the first plate and contacted with the first plate.

15. The LED street lamp as claim 8, further comprising a lamp base, wherein the lighting module and the metal base are connected to the lamp base.
